(19) United States
(12) Patent Application Publication
(10) Pub. No.: US 2021/0056147 A1
(43) Pub. Date: Feb. 25, 2021

(54) Apparatus, System and Method for Facilitating User-Selection of a Commercial Content Provider and Replacing Ad Content Receive with Search Results with Ads from Another Content Provider

(71) Applicant: Michael Pesochinsky, (US)

(72) Inventor: Michael Pesochinsky, Wayne, NJ (US)

(21) Appl. No.: 17/092,231

(22) Filed: Nov. 7, 2020

Related U.S. Application Data
(63) Continuation-in-part of application No. 14/472,464, filed on Aug. 29, 2014, now Pat. No. 10,878,453.

(51) Int. Cl. G06F 16/957; G06F 16/958; G06Q 30/02

(52) U.S. Cl. CPC G06F 16/957; G06Q 30/0269; G06Q 30/0277; G06F 16/986

(57) ABSTRACT

An Internet-based Commercial Content Provider Controller (CCPC) system and method allows individual users to select and modify the commercial content provider, and control which of the commercial content providers is used for providing advertisements that are imbedded with Web pages that the user receives in response to the search requests. The system allows the user to choose the preferred Commercial Content Provider (CCP) and participate in the financial benefits from the delivery of the commercial content to the user from the CCPs.

CCPC maintains a database of ad formats, and allows to replace ads appearing in the Web page and search engine results by reference to the ad pattern database of commonly used ad pattern for the Web sites and for different CCPs. The CCPC allows identification of the user-preferred CCP, automatic recognition of the CCP that is returned with Web search results, automatic generation of a request to a different user-preferred CCP, receiving commercial content from the user-preferred CCP and automatically substituting the received content in place of the original commercial content in the search results.

CCPC also allows to selectively block or blank out ads from certain CCPs, and substitute ads from other CCPs with ads that are separately received from the user-preferred CCP.

This application claims priority under 35 U.S.C. § 120 of U.S. patent application Ser. No. 14/472,464, filed on Aug. 29, 2014, and entitled “A Method, Device and System for a Commercial Content Provider Controller for Controlling Ad Content Provided with Web Page and Search Results”.

### FIELD OF THE INVENTION

The present invention pertains generally to an apparatuses, methods, and systems for automated Internet-based systems for controlling and management and control of the commercial advertisements and content delivered by search engine and browser results. In particular, it relates to systems and methods that allow users to control the delivery and the source of the commercial content ads that are supplied by the search engines and browsers through the custom settings and browser plug-in settings.

### BACKGROUND OF THE INVENTION

The Web advertisement systems in common use today are deeply rooted in the TV-based and print media advertisements, where the user has little or no control over the choice of advertisers and advertisement providers that he or she prefers or selects to accompany the provided content. While the Web-based systems, search engines and Web sites are starting to utilize new possibilities offered by Web, that process is far from being very versatile or fully user-oriented. For example, Web advertisements presently allow user ads that are related to users' searches on the Internet or related to their past searches, often-visited Web sites, geographic location, language preferences and other preferences. However, one of the principles taken from the past advertisement methods on TV and in the print media (newspapers and magazines) is the choice of ad selections. In some cases, the ads provided to each Web site visitor are pre-selected by the site owner, where the site owner has either some proprietary interest or agreement with the advertisers for the delivered and displayed ads. Similarly, when search engine displays search results for the user and displays ads on the Web page for that use, those ads are chosen and selected by the search engine company/owner and served by that search engine's computers/servers.

In other cases, the Web site owners have no vested or proprietary interest in the choice of the displayed ads on their Web site. In such cases, the Web pages delivered to the user (Web site visitor) are dynamically created on the fly based on the search conducted, and possibly other factors. The content for some such ads may be delivered dynamically by the ad provider servers and then inserted into the Web page (HTML for example) that includes the search results and content from the search engine servers. However, the choice and selection of the ads and associated formatting are not left to the user, and the ad content is typically selected by a third party ad agency with whom the Web site owner may have an agreement or by the search engine provider.

While there are different services and computer programs which allow users to manipulate ads on the search engine pages, the choices available to the user are typically as follows: (1) completely block ads; (2) limit the number of ads; (3) define and limit ad locations on the Web page, ad appearance, or even change or modify the ads appearing on the page. These services and programs allow manipulation of the ads delivered by search engines in many ways. However, the current systems miss a number of very important and valuable aspects and choices concerning the ads served to the user. Among other missing aspects and choices that are discussed later, none of the current systems allow user to make selection of his or her preferred choice of the commercial content provider (CCP). Also, there is a lack of a comprehensive system that allows quick and efficient integration and operation with the existing search engines and different browsers, and also quickly adjusts to any changes in the ad formats utilized by the search engines for the delivery of search result content.

There are different and important reasons why some users might want to select and control the choice of which company or person provides them with the commercial content. It could be an objective preference for one provider over another, because ads from one provider are more interesting than from another one. It can be a subjective preference of the user toward the ads from a certain provider, including political, philosophical or some other preferences for a particular provider or opposition to others. It could be related to a stricter privacy protection offered by some CCPs. It could also be based on a contractual agreement between the user and a third party, which requires the user to choose certain CCP over others as a consideration under such contract. Finally, it could also be based on a direct compensation arrangement, where the user is paid by the CCP or shares with CCP the user-generated revenues.

Thus, there is a need for a system that allows greater choices over the ad content and the choice over CCP for the Web page results in general and for search engine users. There is a need for a system to allow users to decide which CCP(s) should provide their ads that appear with the Web page results in general and with search engine results in particular. There is also a need for a comprehensive CCP control management system that allows Web users and search engine users to have multiple options such as selecting no ads, select which CCP(s) should provide ads that appear with the Web and search engine results, control the appearance of the ads presented by various Web pages, search engines and browsers, and optionally allow users to receive certain consideration, virtual currency, points or some other compensation from the CCP for the user-generated revenue. There is also a need for a centralized and efficient ad management system that is capable of supporting multiple Web browsers and that may adjust quickly and efficiently to any changes in the ad formats utilized by various common search engines.

### SUMMARY OF THE INVENTION

It is an object of the present invention to provide an Internet-based Commercial Content Provider Management System that allows each of multiple users that utilizes a computer or a mobile device for accessing and displaying Internet pages with commercial content, conducting

Internet searches and to select and modify the commercial content provider. Another object of the present invention is to allow user to have more control over the commercial content (ads) layout and choice of the content as part of the Web pages in general and search results in particular that are populated and delivered to the user and any dynamic ad content that is delivered by the ad content provider servers into any Web page or search engine result page for the user.

Yet another object of the present invention is to comprehensive CCP control management system that allows Web and search engine users to have multiple options such as selecting no ads, select which CCP(s) should provide ads that appear with the Web pages having CCP and search engine results, control the appearance of the presented ads, and optionally allow users to receive certain consideration, virtual currency, points or some other compensation from the CCP for the user-generated revenue.

Another object of the present invention is to provide a centralized and efficient ad management system that supports multiple Web browsers and also quickly updates its knowledge base and adjusts to any changes in the ad formats utilized by various common search engines.

Still another object of the present invention is ability to control inherent characteristics of ads within specific CCP and within specific regions operated by a particular CCP.

Yet another object of the present invention is to provide a centralized server that may keep the ad content and/or allow access to the ad patterns and ad characteristics utilized by various Web pages with commercial content, search engines and ad servers. It may also allow operators to perform the centralized update of the ad content, ad patterns and ad characteristics, and further providing the updates specific to the search engines and ad content providers for each individual user who request updates from the server. It further allows user to have full control of the ad layout and other ad characteristic, in addition to the selection of CCP provider for the Web page and search engine results displayed on the user device.

These and other beneficial features and advantages of the present invention are disclosed in detail hereinafter with reference to the accompanying drawings and descriptive matter in each embodiment of the invention.

### BRIEF DESCRIPTION OF THE DRAWINGS

FIG. 1 illustrates a flow chart of the process of the user-driven installation of the

Commercial Content Provider Controller (CCPC) system accordance with at least one embodiment of the present invention.

FIG. 2 illustrates a flow chart of the process of delivering search results and ad content to the user in accordance with at least one embodiment of the present invention.

FIG. 3 illustrates a flow chart of the updating process for the CCPC system in accordance with at least one embodiment of the present invention.

FIG. 4 illustrates a flow chart of the process of establishing and creating a user account with the CCPC system and maintaining record of user activity and ad delivery.

FIG. 5 illustrates a general environment and system organization for the user and CCPC in accordance with at least one embodiment of the present invention.

FIG. 6 illustrates one possible arrangement and organization of the ad patterns stored by the CCPC and local computer and quick updating capabilities in accordance with at least one to embodiment of the present invention.

FIG. 7 illustrates one possible arrangement of the communication protocol and exchange of information between the user's computer, CCP ad server and CCPC server and tracking of user activity with at least one embodiment of the present invention.

FIG. 8 illustrates a process of determining when to perform a selective CCP and CCP ad substitution, based on the user settings and preferences in accordance with at least one embodiment of the present invention.

FIG. 9 illustrates a process of determining when to perform a selective CCP and CCP ad substitution, ad formatting, blanking or blocking ads, and other ad modifications in in accordance with at least one embodiment of the present invention.

### DETAILED DESCRIPTION OF THE INVENTION

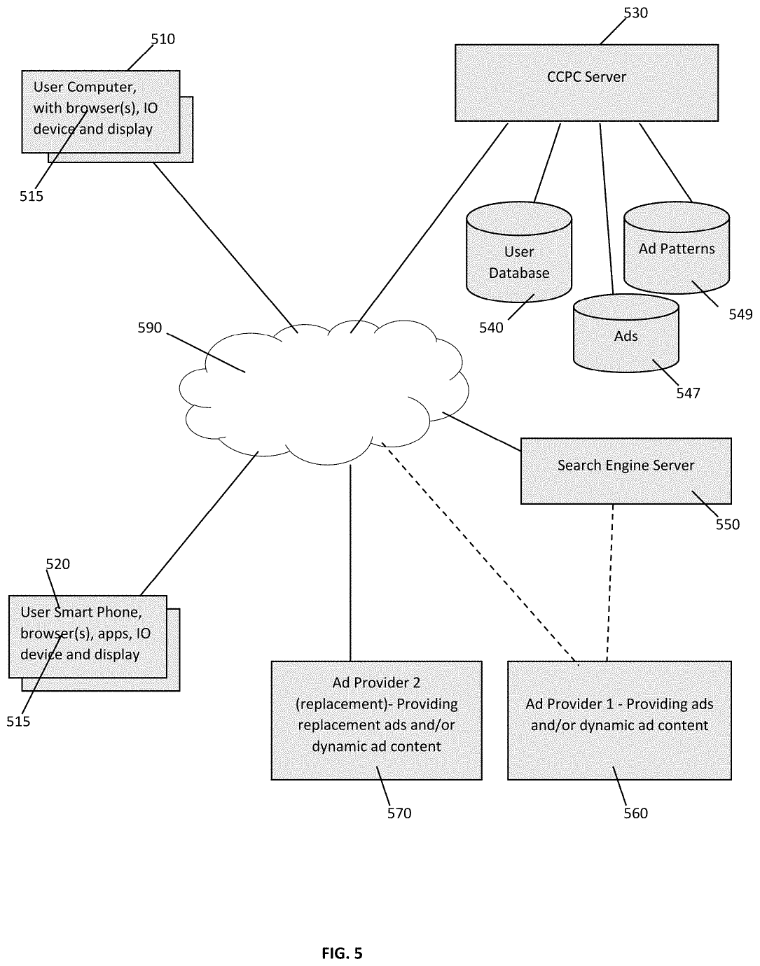

FIG. 5 illustrates a general environment and system organization for the user(s) and CCPC, search engine server(s) and ad server provider server(s) in accordance with at least one embodiment of the present invention. It is understood that there may be multiple computer devices, servers and databases utilized in connection with this description. One or more user(s) can utilize his or her computer 510, a mobile smart phone 520 or another mobile or stationary computer device with a display screen, an input device and equipped with an Internet browser 515 or an app on the smart phone, to allow the processor to execute computer instructions that allow the user to communicate through the Internet 590 and submit search request to a search engine server 550 and receive search result(s) from the search engine server. The user may also communicate through the Internet 590 with the CCPC server 530, which may store user-specific information and ad provider and display preference for the user in a file or database 540, and may also maintain a database of preferred ads 547 and a database of ad patterns 549 for the ads generated by different search engines. The CCPC server 530 may regularly update the database of preferred ads 547, to add any preferred ads that may fit user's preference, and update the database of ad patterns 549 in order to adjust for any changes in the formats or addition of different new ad formats or styles for any of the major search engines.

The search engine server may also communicate either directly or through the Internet 590 with the ad provider 1 server 560, which may provide actual ads or dynamic ad content to populate and display as part of the search results delivered by the search engine server 550 to each user, in response to his or her search request. The ads provided by the ad server 560 are included into search results sent back by the search engine server server 550 to the user.

Irrespective of how the ad content is placed or inserted into the search results, the user may select to replace the ads and/or ad content provided by the ad server provider 1 560 with ad content from another ad provider 2 570. The replaced ad content would be seamlessly inserted into and replace the ads in the search results delivered to and/or displayed the user's computer 510 or smart phone 520 or another Internet-enabled device with a display, for displaying the search results and the ads to the user. The present system allows user to actively choose to replace ads of a particular CCP, such as for example ads from ad provider 1, 560 with ads from another CCP, such as for example ads from ad provider 2, 570. It also allows user to select and control the display format, options and characteristics of the delivered ads, in addition to the origin of the displayed ads.

The user computer 510 or the smart phone 520 is equipped with an Internet browser, or an app, which allows Internet browsing for a smart phone or any other mobile device. Any of multiple commercially available Internet browsers can be utilized.

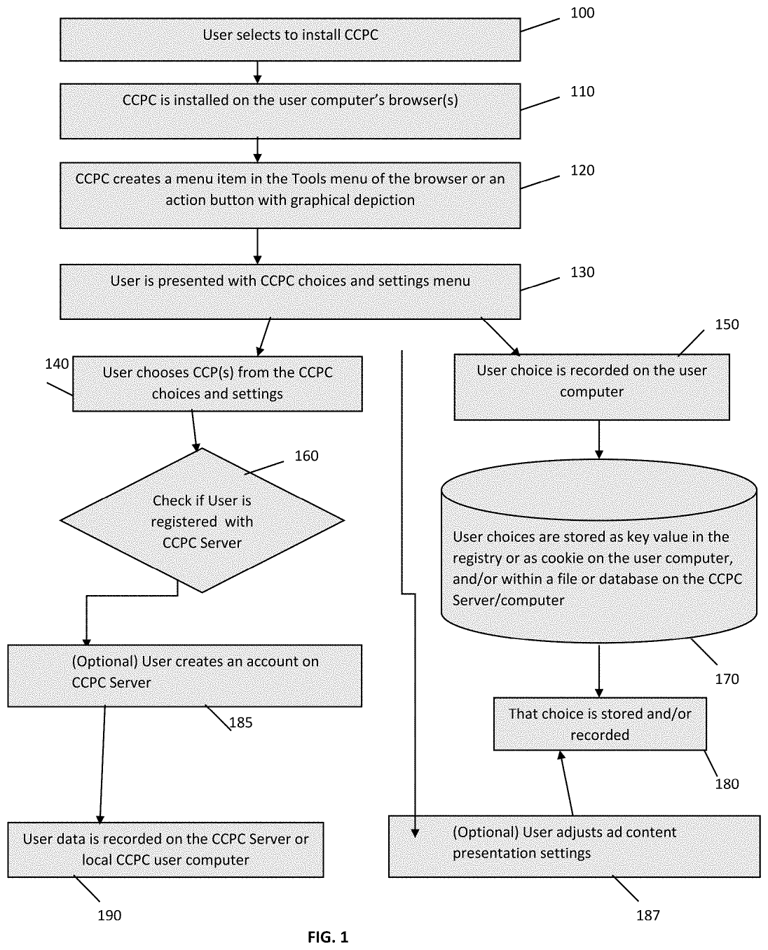

The process of installation and registration of the user with the CCPC is further described with reference to FIG. 1. First, the user is presented with the option to install the CCPC on the user's computer or mobile device, as shown at step 110. The browser may have an integrated module for setting user-specific characteristics for the user, named “Chose your CCP”. Alternatively, if browser does not have such module it can be provided as an add-on/plugin/extension for the browser, which can be installed at step 120 on the computer or mobile device utilized by the user for searching the Internet, and it may also be part of or incorporated into the browser itself. CCPC installation process can be limited to any particular browser selected by the user or it may include installation process for all browsers installed on that computer, smart phone or another Internet search-enabled device.

If CCPC is installed as a plugin, it could also create a menu item in the menu of the browser, if the browser allows modifications to its menu, as shown at step 130. Alternatively, an action button with some graphical depiction can be created on the toolbar in the browser. When mouse or another scrolling or IO device passes over the action button, it will present user with the option to “Chose” or “Configure” his or her CCP, as indicated at step 140. When the button or menu item is selected or activated by the user, the User Interface (UI) for the CCPC will appear. Preferably, the user interface will contain a drop-box with instructions explaining how to select and choose CCP, change or modify the ad display and/or disable ads altogether. The drop-box may contain a number of items and settable options. In one embodiment, it will contain a list of selectable CCPs, with one of them being the default value. When a user clicks on or selects an item in the drop-down box, a particular CCP will be selected, or the default one will be changed. Alternatively CCPs can be presented to the user as checkboxes or through other user display options that allow selection of a CCP and change of a default value. Optionally, the user may select either none of the CCPs or multiple CCPs. The system may also check whether the user is registered on the CCPC server at step 160. If not, he may be asked to go through a registration process at 185, where he sets up a userid and optionally a password, and may also indicate other preferences concerning the CCP, such as the region or language(s) of the presented ads and/or other CCP and ad preferences and settings. The user selections and choices at step may be saved and recorded, as shown at steps 150 and 190, on the user computer as a key value in the registry, stored as a cookie or within a file or database on the user computer, as indicated at step 190 and on the CCPC server, as indicated at step 170. In addition to the selection of the CCP, the user may also be presented with the choices menu at step 130 to select and chose other ad presentation settings, including without limitation the format of the ad display, regional settings, preferred language and other ad-related presentation settings, as indicated at step 187.

These additional choices and settings may also be stored on user computer, as a cookie, additions to the computer registry or some data files stored on the user computer. In addition, the user selections and settings may also be stored and recorded together with the choice of a CCP for that user on the CCPC server, as shown at step 180, indicating choices selections made by the specific user. If stored on the CCPC server, the user information may be identified and extracted from the file or database based on the userid and password that is generated or provided by the user as part of the registration step 185 with the CCPC server.

In addition to selecting CCPC User Interface will allow any other manipulations of the commercial content (ads) and choices concerning CCP and other user preferences. For example, the user may select to completely block ads, limit their amount, define their location on the page, appearance, or make other visual choices and selections concerning ad presentation settings, as indicated at step 187. These choices may also be recorded and saved locally on the user computer and/or on the CCPC server and user settings database. CCPC server may also contain or have access to a database of ad patterns, with the ad appearance for most or all major search engine result, as well as patterns of the major ad networks used on websites other than search engines.

Additionally, CCPC may also allow for a central update or upgrade mechanism, which will connect CCPC servers to various search engine and ad severs and allow to update the database of ad patterns in a given period of time (weekly, daily, hourly or more often). CCPC may provide and store the time stamp for the last update every time it updates its database(s).

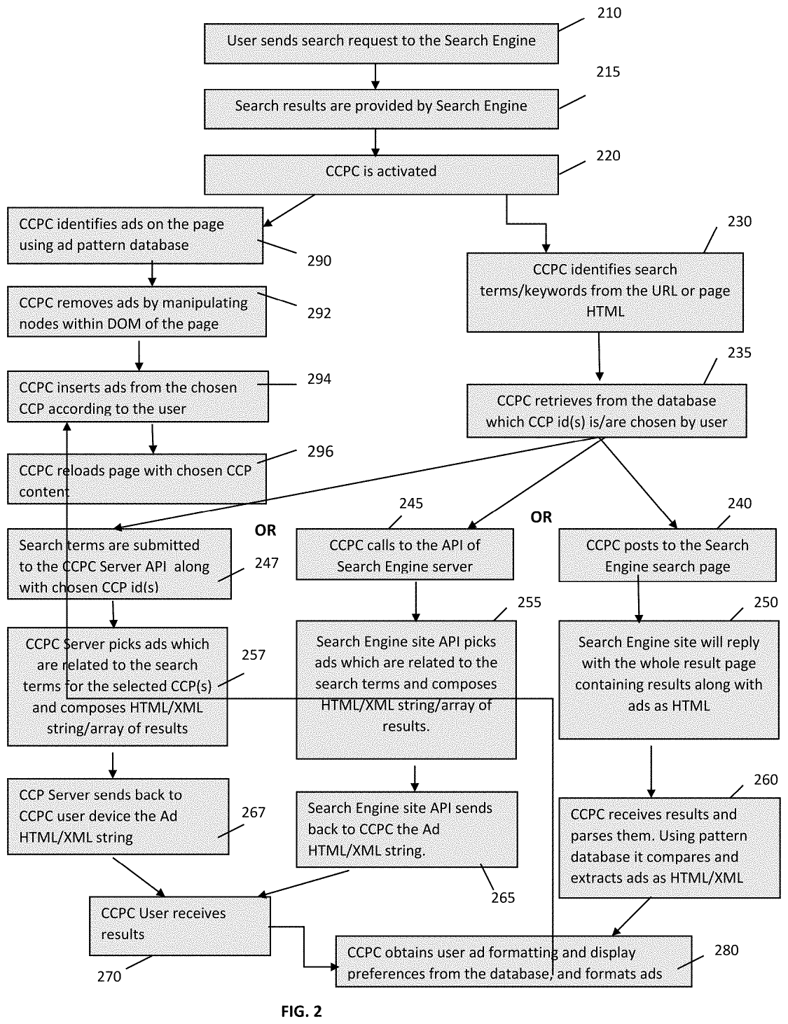

CCPC will have the ability to work with browser requests and responses. Referring to FIG. 2, the user may send a search request to a search engine (one of many different search engines supported by CCPC) at 210. The results for those searches will be entered (written) either on the search engine pages forms or in search engine tool bars. Once a result page is provided by a search engine at 215, the plugin for CCPC in the browser used by the user become activated, as indicated at 220. Then, CCPC will identify keywords used in the search, by taking that value from the input box on the result page or from URL, as indicated at 230. The search terms along with other parameters such as browser type, search engine or page name, geo location, user info, browsing history etc. will be submitted to the CCPC server API, as for example via AJAX. The CCPC server either looks up user-specific settings in the user database that is maintained locally and/or on the CCPC server or, alternatively, receives user preferences from the cookie or registry information stored on the user device, determining, among other user settings and preferences, which CCP id is chosen by the use, as indicated in step 235.

CCPC server will send back to the user, the ad HTML/XML string which will contain ads generated by the chosen CCP(s). Those ads will be chosen based on the search terms along with other parameters such as browser type, search engine or page name, geo location, user info, browsing history etc.

The CCPC server can work in a configuration, where it will host multiple CCPs. Such server will have ads with respective keywords of many providers stored in a database. When request will be send, it will have id's of the requested providers along with keywords. The server will send back ads from each chosen provider for given set of keywords in a given format, as for example as HTML/XML. As soon as response from the CCPC server is received, plugin will parse it, and format it in a user desired format.

Once the CCPC determines the CCP id for a particular user at step 235, it may utilize multiple processes to retrieve and present the ad content from a specific CCP (or multiple CCPs) chosen by the user. The search terms may be submitted to the CCPC server through an API, along with the chosen CCP id(s), as indicated at 247. The server may maintain its own database of ad content and select the ads that are related to the search terms for the selected CCP(s) for a particular user and compose an HTML/XML string/array of ad results, and send the ad HTML/XML string back to the user, as indicated at 267. The user CCPC receives the ad-related string at 270, extract the formats and other ad content display preferences for the user from the database and formats the ad results in accordance with user preferences at 280. The database with formatting information may be kept locally on the user computer or the CCPC may call the CCPC server with the userid for a particular user and obtain the formatting and other display data from the central database on the CCPC server. Once the ad display preferences and ad formats for the user are extracted and processed, the CCPC on the user computer inserts the formatted ads from the CCP of the user's choice and in accordance with the user formatting options into the search result Web page, as indicated at step 294. The resulting Web page(s) are then reloaded in the user browser and displayed on the user display, at 296.

Alternatively, if the CCPC server is not capable to communicate and deliver ads to the user directly, then API calls, as shown in step 245, as for example via AJAX can be made to a specific search engine server, if the search engine server supports an API call access. The search engine server API receives the CCP id or other indicators for the CCP(s) chosen by the user and selects ad content corresponding to the chose CCP(s) and the search terms provided by the user, as shown at step 255. Once the proper ad content is selected by the search engine, it may send through an API the ad HTML/XML string for the ad content back to CCPC, as indicated at 265. The ad content provided by the search engine API is then received by the CCPC at 270, at which point the CCPC may optionally apply user ad display preferences and formatting at 280, insert or modify the formatted ad content in the resulting Web page together with the search results, at 294 and reload the resulting Web page to affect the resulting display to the user, at 296.

If a particular search engine does not have a specific API for processing and delivering ads for an indicated CCP selected by the user, then CCPC can determine which Search Engine will provide the ad content that corresponds to the user-selected CCP and make a post to the search engine server page using XMLHttpRequest object or similar call, as indicated in step 240. The post/request will have keywords within its parameters. The site will reply with the whole result Web page containing search results along with ads that are chosen by the search engine rather than the user, as indicated at step 250. In that case, at step 260, the CCPC plugin will identify ads presented by the search engine using an ad pattern database and remove the search results, keeping only the ads content for CCP provided by the search engine, which corresponds to the user-selected CCP. The ad patterns may be stored centrally on the CCPC server, with updated copies for the particular user on the user computer, possibly as files or a small database in the computer or external memory. Alternatively, user CCP may make calls to the CCPC server and receive updated ad patterns. Then, the CCP and the Plugin on the user computer will take those ads and format them in a user-desired format and also apply user-selected ad display options, at step 280. Then the ad content corresponding to the CCP of user choice is inserted and combined with the search results, which may be those from a different Search Engine that called at 240. Once the search results are combined with the formatted ad content, the resulting Web page is displayed to the user at 296.

In at least one other embodiment, the formatting options of ads can be adjusted in the display of the user-preferred content to the more detailed levels. For example, the user may specify that he or she does not desire ads to be placed over certain Web pages, from certain Web sites or links. The processor on the CCPC server (or local to the user computer) will then operate the software that will have a selection of certain ads for certain links/sites specific to a particular user. In at least one embodiment, the user can choose not to see any ads for certain Web sites or links. In such a case, the CCPC server will not include any alternative CCP ad content in place of the removed original ad from the non-preferred CCP. Thus, the user indication that he or she does not prefer any ads from a particular Website will operate to remove the content from the web search results for the original request, but will not generate a call to the preferred CCP and will not replace the removed ad content with a substitute ads from the preferred CCP. Thus, the system will operate as an ad blocker.

As shown at step 290, the second function of the plugin which is processed concurrently, is to remove the original ad content provided by the search engine result and replace the ads with the CCP ads of the user preference, provided by the CCP that is preferred and selected by the user. In order to identify original ads the pattern database will be used. Patterns will be compared to the page content for that specific search engine web page. Then by doing DOM (Document Object Model) nodes insertions and deletions, the original ads are removed and replaced with the CCP server ads, as indicated at steps 292 and 294, the latter chosen in accordance with the user settings and preferences. CCP server ads are then added to the Search Result Web Page in any desirable fashion at any position typically reserved for the ad content. It can be a single ad block or multiple blocks. The ad content may be with or without images, as a part of a geo map, etc. There are no limitations on the presentation of the ads on the resulting page. Once the ad content provided by the CCP of the user choice is inserted into the Search Result Web page HTML, the newly formed page is loaded on the user computer from the local memory. As discussed above, the formatted ad content may come directly from the ads maintained and processed by the CCPC server, as indicated in the process following the steps from 247, or it can be the ad content for a specific CCP provided by the search engine API, as indicated in the process following the step from 245. Also, it could be the ad content that is extracted from the full search result Web page by the CCPC, after it posts to the appropriate

Search Engine search page and extracts the full search result page and ad content, and then removing the search results, while keeping an formatting the ad content, as indicated in the process following the steps from 240. As a result, the display on the user device will present to the user, at step 296, and the user will see ads from his choice CCP, displayed in the format that is preferred and selected by the user, and also including other ad display preferences chosen by the user.

Such technique will be used on every major search engine, and can be used on any other websites, for as long as it does not violate copyrights of such sites. For example, many websites have section of their pages dedicated to the advertisement. They display ads from their choice CCP. Unlike ads from the search engine's pages, this ads show content based on user characteristics and his prior searches or browsing history. The pattern of such ads is determinable and can be matched. In this case CCPC could parse every page HTML before displaying. Then as it was explained above CCPC will analyze page HTML, detect ads if they are matching known patterns. Then it may remove that portion of the HTML and manipulate DOM to substitute it with ads from chosen CCP.

In some embodiments, the CCPC processor may execute instructions that will operate to treat different web pages, coming from differed CCPs differently. In some cases, the processor may evaluate formatting options for the content and ads coming from different CCPs. In ate lest one embodiment, the CCPC may execute computer instructions that will allow the system to selectively, for some CCPs, depending on the automatically evaluated source of ads, abort or not execute the aforementioned CCP and ad substitution, and allow some web page (depending on the evaluation of the selective conditions related to the CCP attributes, source of ad attributes or some user-specific conditions) to be displayed “as is”, with original ad content. This is referred to a as “rejecting” the substitution processing for the ad content. The rejection of the substitution of ad content can be implemented based on the user-specified or otherwise evaluated characteristics of certain Web pages, URLs, IP addresses and/or geographic location of the CCP, user computer and/or the ad content.

Each of these factors may be evaluated separately, or can part of a larger overall evaluation in any combination or permutation with other factors. The factors can be given different weights in the overall analysis. In some embodiments, the user can specify the importance of some factors, and the evaluation will attach different weight or priority based at least in part on the user setting.

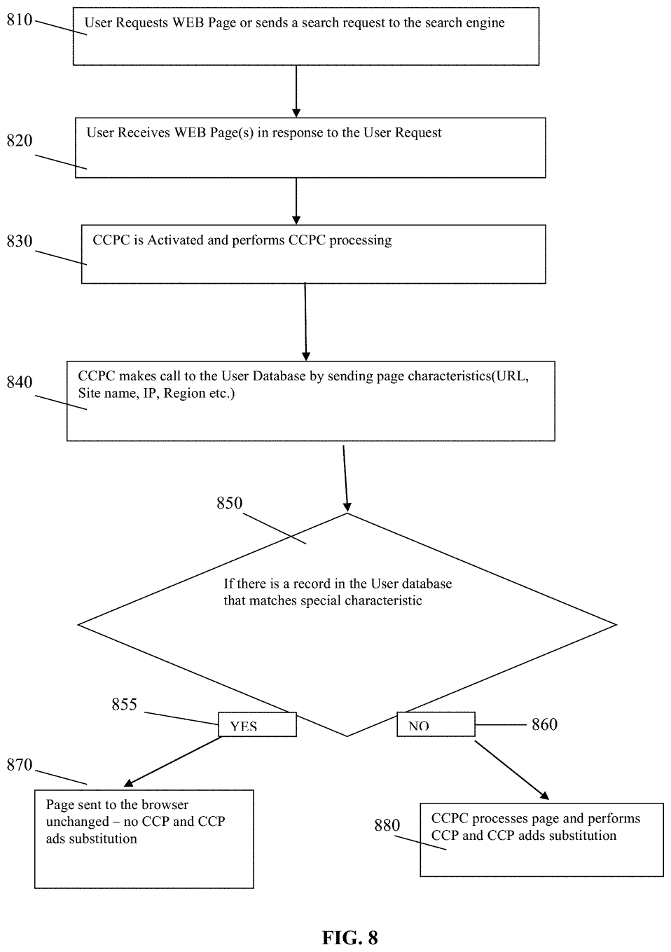

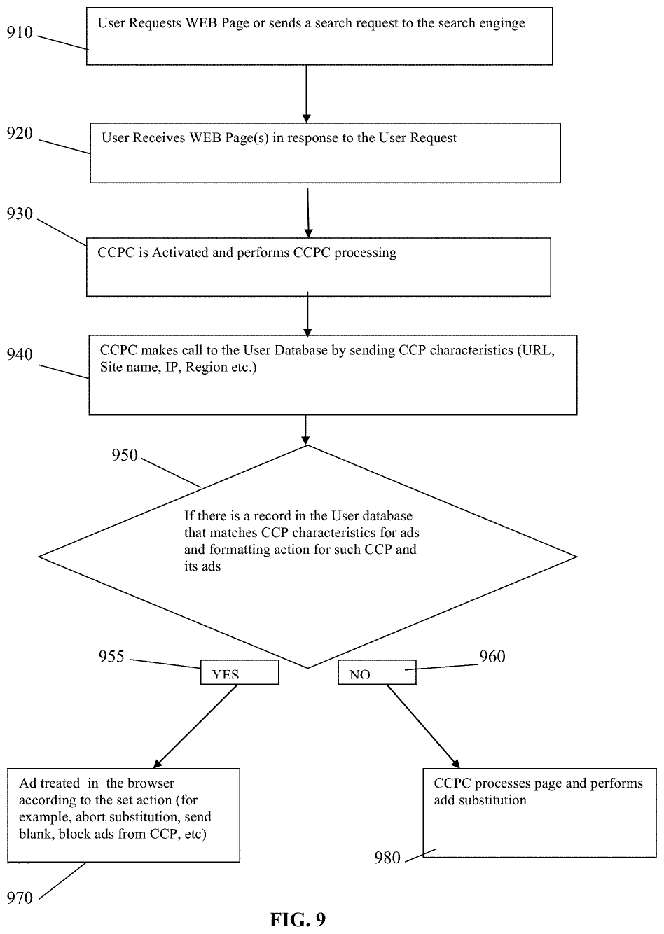

The operation of selective CCP substitution, based on the user setting or preferences, is illustrated in more details with reference to FIG. 8 and FIG. 9. The user submits a search request 810 or otherwise requests a Web page from some website, search engine, etc. The response with the Web page results 820 is sent back to the user's computer. The user computer then either executes the software related to the CCPC processing 830 on the user computer or connects and calls a remote CCPC server for executing the CCPC processing in accordance with at least one embodiment of the present invention. The CCPC processor executes computer instructions that cause the processor to access and evaluate 840 the User Preference database (or data). As part of this evaluation, the CCPC processor may compare or analyze 850 the URL, site name, IP address, geographic region, or other request characteristics (or a combination of the individual characteristics) for the received Web page results 820, and compare these characteristics against the user preferences in the User Preferences database or data files.

If the comparison (or analysis of multiple factors) 850 indicates a “match” or “yes” at 855, it may cause the processor to determine that there should be no CCP substitution and no ad substitutions for the ad received from a particular CCP. In such a case, the CCP and the ad content from the CCP that is included in the Web page results in 820 is left unchanged 870, irrespective of whether the user has indicated and selected a different “preferred” CCP.

If the result of comparison (or analysis of multiple factors) 850 indicates a “no match” or “no” at 860, then it causes the CCPC processor to execute and perform ad substation 880 with the ads of the preferred CCP. In other words, if the Web results to the user request come from different CCPs—A, B and C, the present system, in accordance with the described embodiment may substitute the ad content only from some CCPs (A and B), replacing it with the ad content from a preferred CCP X. In addition, based on the evaluation of user preferences, it may leave unchanged the ad content from other CCPs (C) if such preferences are set and stored as part of the User Preferences in the User Preferences Database or data file for the user.

Another variation of the selective CCP ad content substation (with formatting options) and based on the CCP characteristics, is explained with reference to FIG. 9. The user submits a search request 910 or otherwise requests a Web page from some website, search engine, etc.

Then, the user receives a response with the Web page results 920 and executes the software related to the CCPC processing 930 on the user computer or connects and calls a remote CCPC server for executing the CCPC processing. The CCPC processor identifies the CCP 940 as the source of the ads that appear in the returned Web page results. It then accesses and evaluates 945 the User Preference database (or data). As part of this evaluation, the CCPC processor may compare or analyze 950 the URL, site name, IP address, geographic region, or other characteristics request characteristics (or a combination of the individual characteristics) for the particular ad on the received Web page results 920, and may also evaluate the ad formatting instructions that may be set for the specific CCPs or for the specific ads.

If the comparison and analysis of the CCP characteristics at 950 indicates a “match” or “yes” at 955, it may cause the processor to perform certain user-preferred ad treatment for the particular ad. For example, it may determine that there should be no CCP substitution and no ad substitutions, insert a blank ad or remove the ads (without ad substitution), block ads or reformat ads from some CCPs. If the result of comparison (or analysis of multiple factors) 950 indicates a “no match” or “no” at 960, then it causes the CCPC processor to execute and perform ad substitution 980 with the ads of the preferred CCP.

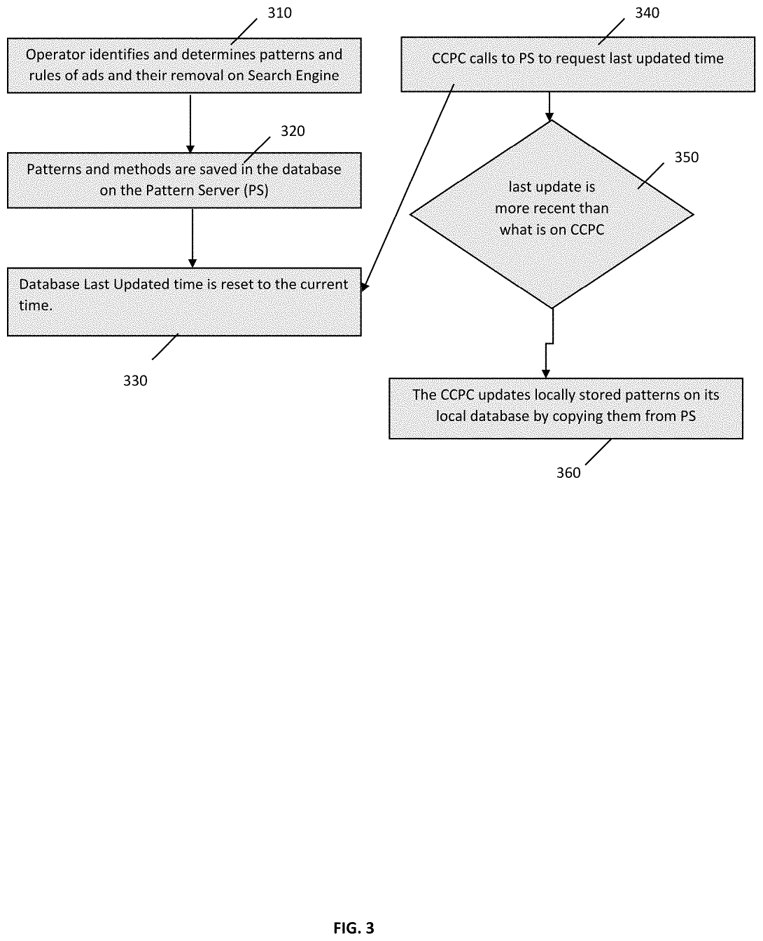

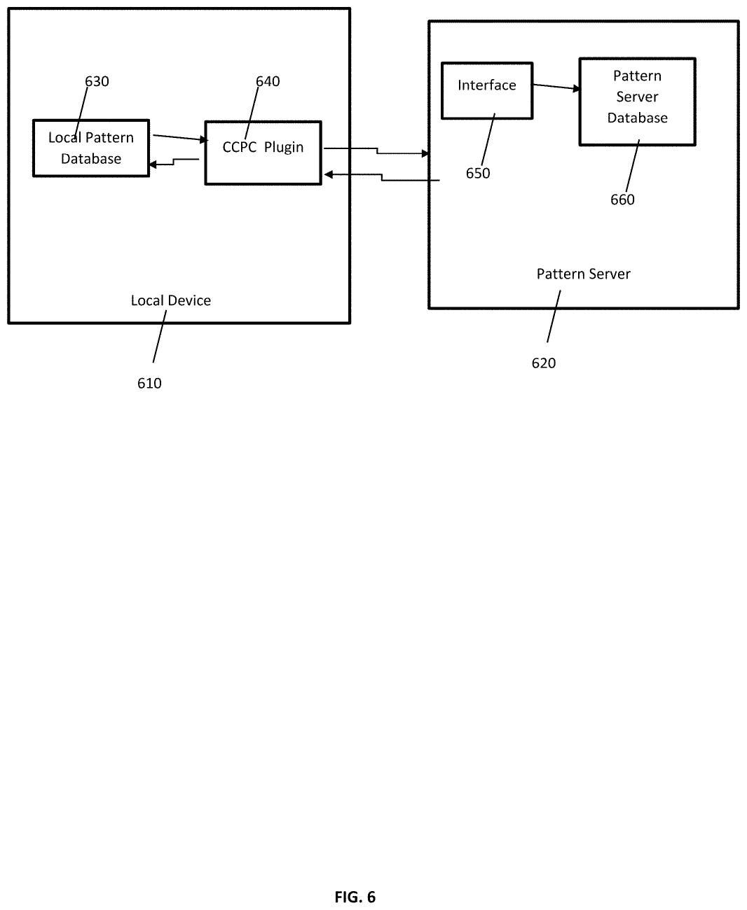

The update functions of the CCPC are described with reference to FIG. 6 and FIG. 3. In order to successfully remove an unwanted commercial content from Web pages, the CCPC server and/or the CCPC on the user computer should have an up-to-date database of ad patterns. Updates to these ad patterns can be done by connecting and/or establishing communications between the user computer 610 and the Pattern Server (PS), which may reside on the CCPC server 620 and store multiple add patterns for various search engines and ad service providers in a PS database 660. Alternatively, the CCPC server may access the PS database on a different server by generating for example SQL command to obtain proper ad patterns for a particular search engine and then store those pattern in computer memory on the CCPC server (which may be temporary or permanent memory), and further to communicate and send some the updates of the ad patterns to the user device 610. The communications between the user device 610 and the PS database 660 may preferable be done through a CCPC Plugin 640 on the user device and the interface 650 on the CCPC server. The user computer or other device may also store the updated ad pattern in the local memory, file, database or any other memory residing in on or accessible by the user device 610. This local copy of the ad patterns stored on the user device reflects only the updates to ad patterns that are relevant to the search engines and ad servers utilized by that user. The PS database 660 may contain a much broader set of ad patterns, applicable to other users, search engines, CCPs and geographic regions.

The PS database will store known patterns of ads for all largest and most commonly used search engines and other CCPs. It will have patterns for all possible ad appearances, particularly for different regions and languages, where different regions and users in different countries are presented with different appearance of ads and search results on the Web pages from the same Search Engine. The PS User Interface will be used to save and edit records of ad patterns in that database. Patterns will be identified manually or with some programmatic tools by analyzing HTML of the pages and extracting the ad portion of the html, and finally defining a rule for specific pattern, wherein that pattern is reappearing on various permutations of dynamic search result pages. A complete pattern record will have pattern beginning string and pattern end string. Alternatively, it might be node names for DOM, or functions in JavaScript. Every time when a record is saved in the database, the database “Last Updated” value will be reset to the current time. It may be called Last Update Time (LUT) PS and may be connected to the Internet using some protocol, like for example HTTP. CCPCs installed on individual user computers or user device may periodically connect and receive updates of the ad patterns from the PS. The PS 620 will have one or multiple centralized databases, which contain up-do-date ad patterns for various search engines. The updates to the ad patterns on the CCPC may be done in any specific time intervals, weekly, daily or possibly more often. The CCPC on the user computer may update its locally stored ad patterns though the communications and transmissions through the CCPC Plugin 640 and PS interface 650 on the PS. The local pattern database 630 on the user CCPC will be updated directly from the PS when the update of patterns is required. The PS will update its stored patterns in its PS database, and will only need to provide updates to the CCPC on the user computer if the timestamp or update indicates that the user does not have the latest ad formats for the particular region or country. The CCPC will request LUT from PS, and if that LUT will be later than previously saved time of update stamp, then CCPC will need to run an update for its local ad pattern 630.

Referring to FIG. 3, the operator on the CCPC server and/or PS may identify and determine updates or some new ad patterns and ad display formats and rules, as well as ad removal procedures for a search engine ads, as indicated at step 310. It should be noted that PS may be incorporated as part of CCPC server or may be a separate server accessible by CCPC server. The identified updates and new ad patterns, rules, ad removal procedures and other content related information for one or more search engines and ad content servers is then placed in the PS database. Once stored in the PS database, it may include a time stamp. When the user CCPC calls or communicates to the PS database to request the last updated time stamp at 340, the PS may compare the “last update” time stamp and/or the update version on the user CCPC, in the local database, with the time stamp and/or the update version on PS, as shown at 350. If the last update of relevant ad content on the user CCPC is older than that of the PS, the CCPC may update the local database of the stored ad patterns on the user CCPC by receiving, copying and storing the relevant ad patters from the PS database. Any number of data exchange protocols may be used to transfer the updated ad patterns from the PS database to the local pattern database on the user device.

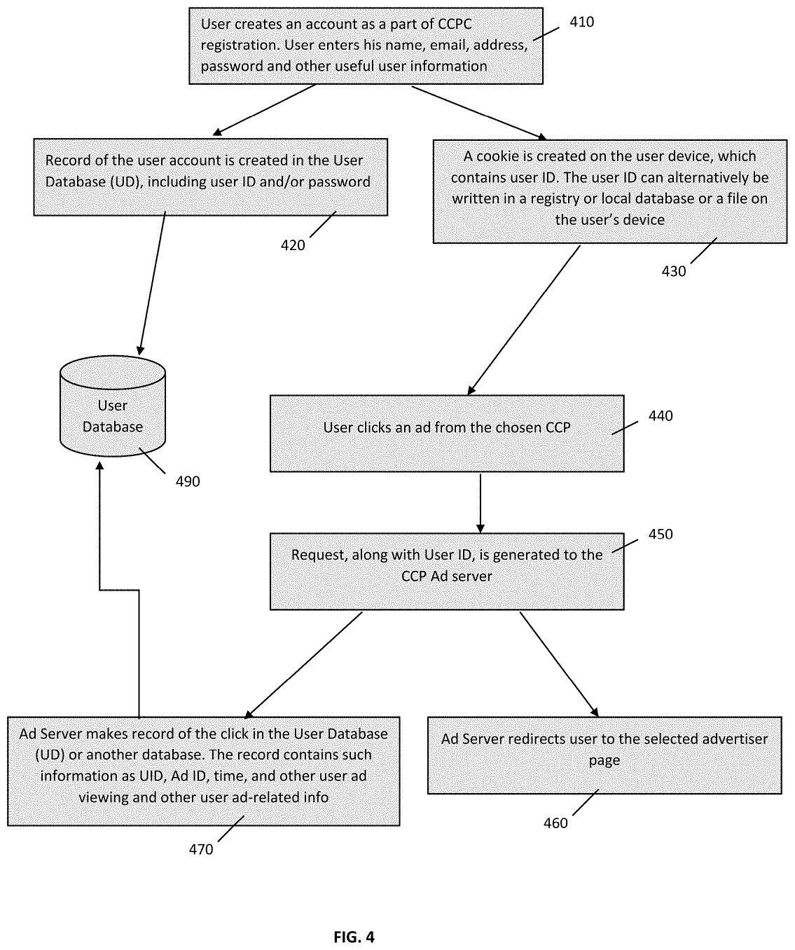

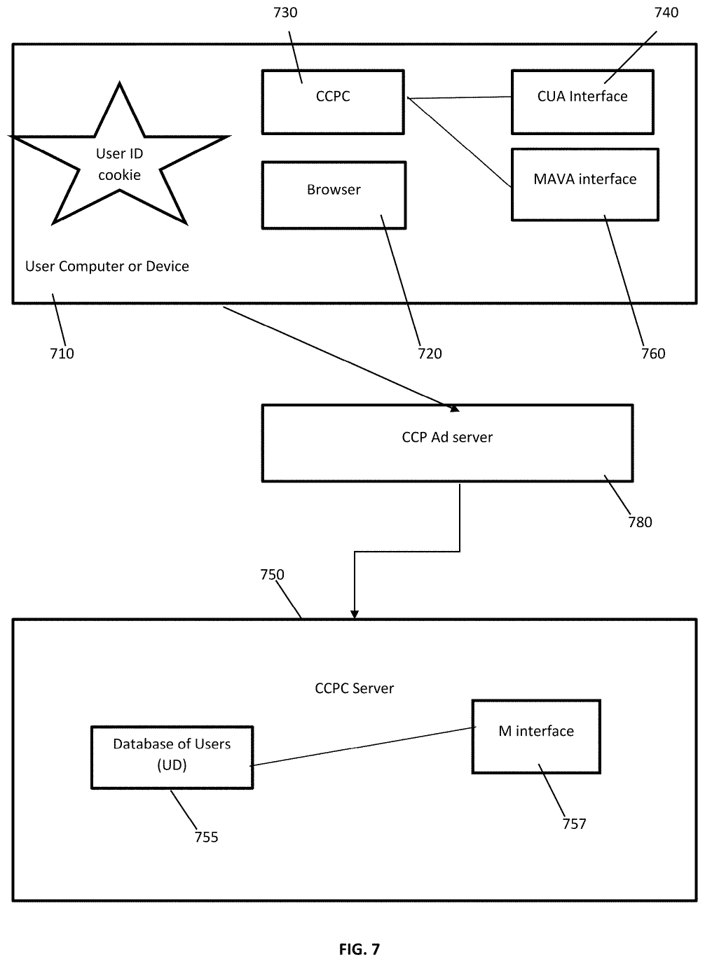

The processing and registration of the user-related information by the CCPC server is described with reference to FIG. 7 and FIG. 4. The CCPC might want to keep track of user's activity related to the commercial content and other ad-related activities of the user. It might be needed to see which specific ads were clicked or not clicked by which user, when the user prefers to receive the commercial content, whether the user responded and selected any of the delivered commercial content and also to keep track of other user choices and activities. This is particularly important when CCP offers some kind of incentive, like loyalty points, virtual cash or some other payment or incentive offered to the user for using, viewing or taking any particular action in response to the delivered commercial content. In order to track user's activity within a CCP content, the system may utilize an additional user management module or server.

In one possible configuration, the CCPC server 750 contains and stores user-specific information in a User Database (UD) 755 on the server computer system, or accessible by the CCPC server. Among other user-specific data, the UD may store user data such as (a) user personal information, and (b) user ID and/or password. Another type of data stored in the UD will include information on (a) ads clicked by a user and/or (b) choices and actions of the user in response to being presented the ad content. It may also contain such data as ad id, user id, time of the click, whether user initiated any further actions, purchases or other activities in response to the presented ad content. Ad id may be provided by the internal CCPC ad server, or a third party ad server (or the search engine providing the ad content).

CCPC on the user device may have two or more additional interfaces. First, the interface to create user account (CUA Interface), 740. Second, interface to manage and view account activity (MAVA interface), 760. It will also have a browser 720 and CCPC Plugin 730 for communicating over the Internet with CCPC server 750 and ad server 780. Lastly, CCPC server 750 might also have the management interface which will allow to create, delete and edit user accounts, as well view and edit user activity.(M interface) 757. The user information about other users on the CCPC server will not be open to an individual user (for privacy reasons) and will typically be utilized by the server CCPC for the purposes discussed above. The M Interface might allow an individual user to access his own data and review his own activities, ad content, incentives, etc. Each of these interfaces can be implemented within a browser and be connected via some protocol like http or https.

When a user choses to use a CCPC and it will need to identify such user, the CCPC on the user device may open or provide communication to the CUA Interface 740. The CUA Interface will allow user to enter his name, email, address, password and other useful user-related information and preferences, as indicated in step 410 in FIG. 4. After successful creation of user account, a record will be created in UD and may include userid and other user data, as indicated at step 420. At the same time, the CCPC on the user computer may store in or create a cookie, which contains the user ID, as indicated at step 430. The user ID can alternatively be written in a registry or local database or a file on user's computer.

While browsing the Internet, the user may click on an ads from the chosen CCP, as indicated at 440s, each ad link responsive to the user's click may contain at least the following information: UserID, Ad ID. Respectively, when clicked that link will be generating request to the CCP Ad server, as indicated at step 450. Besides redirecting user to the advertiser's web page at step 460, that server will be making a record of the click, related ad information and further user actions (at step 470) and may store this information in the UD, as indicted at step 470. The record may contain information related to UID, Ad ID, time, and optionally other info like IP, location etc. Notice that CCP Ad server can be the same or different computer as CCP User Server. Respectively the database of user-related information can instead be a part of some bigger Ads database.

Once account for User Management is created, MAVA interface 760 becomes available for the user. When invoked it will prompt user to enter user name and password. Once the user is logged in, he will be able to view, edit, track and operate on this account information. Among other things, he may be able to view his browsing ads activity for that CCP and any incentives associated with those activities.

Whenever user accounts or browsing activity will need to be managed by CCP, the M interface 757 will be invoked. Operator will be able to add, delete or edit information related to the user account or to browsing activity of a user. Optionally, M interface may also perform other functions related to operation of user's actions and reactions to the ad content provided by the CCPC. It can also monitor the incentives provided to users and can help direct the best incentive packages and offers to the specific users. Other uses and options are contemplated by this invention.

The above embodiments are provided for illustrative purposes and are not intended to limit the user's ability to control commercial content to any specific embodiment. For example, if a particular browser on the CCPC user device allows it, the CCPC may skip the step of initial loading of a page. Instead, the CCPC server may intercept the submitted url before submission by the user, and may also extract keywords from that url or Request variables. Then, it may submit a request to the Ad server based on keywords. At the same time, the CCPC may also submit request to the search engine. Both resulting responses my then be formatted and merged together according to the user preferences. Subsequently, the resulting page is formatted and displayed to the user.

As another alternative, it may be possible to process, format and manipulate pages on the Server or on the individual user computer/smart phone. Depending on processing power and bandwidth available for the user device, some of the steps described above in connection with the CCPC server may be done on the individual user's computer or mobile device. For example as an alternative, the heavy server and light client configuration may perform all database storage and data access processing on the server and only send incremental updates and changes to the individual user device. Such design and alternative might be useful for the individual user computers/smart phones with low memory capacity and low processor speed. In such alternative, the CCPC server contains or has access to a database for all sites on which Ads are to be replaced are stored. The database contains at least a table where the following info is stored: site url, domain name, ad type (if needed), method of substitution, the HTML patterns and DOM Selectors which are used to replace ads. When a site transmits a Web page/is loaded e.g. example.com, the CCPC will query server for the site existence in the server database. CCPC also will submit id of the user choice CCP and search keywords. If a particular Web site is in the database, the server will process it. First it will take ID of the chosen CCP along with keywords and will return Array/XML of ads from the ads server corresponding to the terms of search and from the chosen CCP. At the same time it will retrieve from the database method of substitution along with patterns or DOM elements. Both ads array/xml and patterns or DOM elements are then returned to the CCPC local user device. The CCPC will parse original HTML, remove original ads and merge Content together with new ads. Then, the resulting page HTML is reloaded and displayed on the user device.

CCPC can also be installed as an app on a mobile device which will externally control the user's smartphone or some other mobile device browser functionality and operation. This optional configuration may be useful for the mobile devices where the installed browser does not allow plugins.

Other possibilities, including finer selection within a chosen CCP, are also contemplated. For example some CCPs might allow certain content limited subsets of ads. So, a user can always select such limitations. An example of such subset would be ads approved for children or ads for “Made in USA” goods only, etc. In such case, the requests from the user will have Subset ID along with CCP id. And the ad server will pick only ads of chosen kind in response.

The above embodiments and illustrative descriptions of the application of the principles of the present invention are intended to enable a person skilled in the art to make or use the disclosed invention. They are not intended to be either exclusive, exhaustive or limiting on the scope of the invention described and claimed herein. Other variations or modification could be used and applied by a person skilled in the art without deviating from the scope and spirit of the present invention. Such modifications and alternatives arrangements are not intended invention to be outside the scope of the present invention and are intended to be covered by it. The invention title and abstract are not intended to limit the claimed invention or cover multiple embodiment and all various features of the claimed invention.

It will be understood by those skilled in the art that each of the above steps or elements of the system will comprise computer-implemented aspects, performed by one or more of the computer components described herein. For example, any or all of the steps of collection, evaluation, processing and modeling of the frustration factors and data may be performed electronically. In at least one exemplary embodiment, all steps may be performed electronically—either by general or special purpose processors implemented in one or more computer systems such as those described herein.

It will be further understood and appreciated by one of ordinary skill in the art that the specific embodiments and examples of the present disclosure are presented for illustrative purposes only, and are not intended to limit the scope of the disclosure in any way.

Accordingly, it will be understood that various embodiments of the present system described herein are generally implemented as a special purpose or general-purpose computer including various computer hardware as discussed in greater detail below. Embodiments within the scope of the present invention also include computer-readable media for carrying or having computer-executable instructions or data structures stored thereon. Such computer-readable media can be any available media which can be accessed by a general purpose or special purpose computer, or downloadable through communication networks. By way of example, and not limitation, such computer-readable media can comprise physical storage media such as RAM, ROM, flash memory, EEPROM, CD-ROM, DVD, or other optical disk storage, magnetic disk storage or other magnetic storage devices, any type of removable non-volatile memories such as secure digital (SD), flash memory, memory stick etc., or any other medium which can be used to carry or store computer program code in the form of computer-executable instructions or data structures and which can be accessed by a general purpose or special purpose computer, or a mobile device.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the invention may be implemented. Although not required, the inventions are described in the general context of computer-executable instructions, such as program modules or engines, as described earlier, being executed by computers in networked environments. Such program modules are often reflected and illustrated by flow charts, sequence diagrams, exemplary displays, and other techniques used by those skilled in the art to communicate how to make and use such computer program modules. Generally, program modules include routines, programs, objects, components, data structures, etc. that perform particular tasks or implement particular abstract data types, within the computer. Computer-executable instructions, associated data structures, and program modules represent examples of the program code for executing steps of the methods disclosed herein. The particular sequence of such executable instructions or associated data structures represent examples of corresponding acts for implementing the functions described in such steps.

Those skilled in the art will also appreciate that the invention may be practiced in network computing environments with many types of computer system configurations, including personal computers, hand-held devices, multi-processor systems, microprocessor-based or programmable consumer electronics, networked PCs, minicomputers, mainframe computers, and the like. The invention is practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the inventions, which is not illustrated, includes a general purpose computing device in the form of a conventional computer, including a processing unit, a system memory, and a system bus that couples various system components including the system memory to the processing unit. The computer will typically include one or more magnetic hard disk drives (also called “data stores” or “data storage” or other names) for reading from and writing to. The drives and their associated computer-readable media provide nonvolatile storage of computer-executable instructions, data structures, program modules, and other data for the computer. Although the exemplary environment described herein employs a magnetic hard disk, a removable magnetic disk, removable optical disks, other types of computer readable media for storing data can be used, including magnetic cassettes, flash memory cards, digital video disks (DVDs), Bernoulli cartridges, RAMs, ROMs, and the like.

Computer program code that implements most of the functionality described herein typically comprises one or more program modules may be stored on the hard disk or other storage medium. This program code, as is known to those skilled in the art, usually includes an operating system, one or more application programs, other program modules, and program data. A user may enter commands and information into the computer through keyboard, pointing device, a script containing computer program code written in a scripting language or other input devices (not shown), such as a microphone, etc. These and other input devices are often connected to the processing unit through known electrical, optical, or wireless connections.

The main computer that effects many aspects of the inventions will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), and wireless LANs (WLAN) that are presented here by way of example and not limitation. Such networking environments are commonplace in office-wide or enterprise-wide computer networks, intranets and the Internet.

When used in a LAN or WLAN networking environment, the main computer system implementing aspects of the invention is connected to the local network through a network interface or adapter. When used in a WAN or WLAN networking environment, the computer may include a modem, a wireless link, or other means for establishing communications over the wide area network, such as the Internet. In a networked environment, program modules depicted relative to the computer, or portions thereof, may be stored in a remote memory storage device. It will be appreciated that the network connections described or shown are exemplary and other means of establishing communications over wide area networks or the Internet may be used.

Calculations and evaluations described herein, and equivalents, are, in an embodiment, performed entirely electronically. Other components and combinations of components may also be used to support processing data or other calculations described herein as will be evident to one of skill in the art. A computer server may facilitate communication of data from a storage device to and from processor(s), and communications to computers. The processor may optionally include or communicate with local or networked computer storage which may be used to store temporary or other information. The applicable software can be installed locally on a computer, processor and/or centrally supported (processed on the server) for facilitating calculations and applications.

In view of the foregoing detailed description of preferred embodiments of the present invention, it readily will be understood by those persons skilled in the art that the present invention is susceptible to broad utility and application. While various aspects have been described in the context of a preferred embodiment, additional aspects, features, and methodologies of the present invention will be readily discernible from the description herein, by those of ordinary skill in the art. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention.

It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the present inventions. In addition, some steps may be carried out simultaneously.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

Accordingly, the scope of the present inventions is defined by the appended claims rather than the foregoing description and the exemplary embodiments described therein. While certain exemplary aspects and embodiments have been described herein, many alternatives, modifications, and variations will be apparent to those skilled in the art. Accordingly, exemplary aspects and embodiments set forth herein are intended to be illustrative, not limiting. Various modifications may be made without departing from the spirit and scope of the disclosure.

What is claimed is:

1. An automated system comprising:
a user device having a display, a non-transitory computer memory and a computer processor, said processor disposed in communication with said memory and configured to execute computer instructions stored in the computer memory, and causing the automated system to:
obtain identification information of a first commercial content provider, who provides commercial content from multiple advertisers, wherein the identification of the first commercial content provider is based on a preference of a user of the device;
select and store the identification information of the first commercial content provider as the user-preferred first commercial content provider;
submit a Web page request and receive at least one Web page result responsive to the request;
perform automated recognition processing and identify a position of a commercial content from a second commercial content provider in the Web page result, wherein the second commercial content provider is different from the user-preferred first commercial content provider;
generating a request to a server of the user-preferred first commercial content provider;
obtain a separate response from the user-preferred first commercial content provider, the response comprising at least one commercial content provided by the first commercial content provider;
automatically modify by replacing the commercial content received from the second commercial content provider in the Web page result with the commercial content from the first commercial content provider; and
display the modified Web page result with the substituted commercial content on a display screen of the user device.

2. The system of claim 1, wherein the recognition processing and automatic modification use one of a document object model nodes, an HTML code, or an XML code.

3. The system of claim 1, wherein the processor issues additional instructions to:
store the display at least one format preference in the memory of the user device;
extract the at least one stored format preference; and
format the user-preferred first commercial content provider, in accordance with at least one format preference.

4. The system of claim 1, wherein the processor issues additional computer instructions to perform automated recognition processing of a digital content of the Web page result by comparing it against a database of advertisement patterns and identify the second commercial content provider, whose commercial content is included with the Web page result.

5. The system of claim 1, wherein the Web page request is transmitted through a network to a search engine, and the Web page result includes at least one commercial content from the second commercial content provider on one ore more Web pages.

6. The system of claim 1, wherein the processor issues additional instructions to:
receive and store a plurality of advertisement patterns used by the second commercial content provider;
replace the commercial content included with the Web page result by using and applying said ad patterns for recognition processing.

7. The system of claim 6, wherein the processor issues additional instructions to:
update the stored advertisement patterns with the changes to advertisement patterns and formats used by the second commercial content provider.

8. The system of claim 7 wherein the processor issues additional instructions to:
update the stored advertisement patterns with the changes to advertisement patterns and formats used by the first commercial content provider.

9. The system of claim 1, wherein the processor issues additional instructions to:
allow the user to select at least one option for determining the display format of the Web page result and stores said user selection;
apply the selected user option to format web page results and display the formatted Web page result on the user device.

10. The system of claim 1, wherein the user device comprises a personal computer.

11. The system of claim 1, wherein the user device comprises a mobile device.

12. The system of claim 1, wherein the at least one Web page result responsive to the user request are presented and displayed to the user unchanged if a certain criteria, determined at least partially based on user preferences is met, and wherein the at least one Web page result responsive to the user request are presented and displayed to the user with modified and substituted commercial content from the preferred first commercial content provider.

13. The system of claim 1, wherein the at least one Web page result responsive to the user request are selectively presented and displayed to the user either unchanged, with blanked out commercial content, with blocked commercial content, or with formatted commercial content, and wherein the at least one Web page result responsive to the user request are presented and displayed to the user with modified and substituted commercial content from the preferred first commercial content provider based at least partially on the ad characteristics specified or determined for different commercial content providers.

14. A method for displaying a commercial content on a user device, said method comprising:
obtaining identification information of a first commercial content provider, who provides commercial content from multiple advertisers, wherein the identification of the first commercial content provider is based on a preference of a user of the device;
selecting and storing the identification information the user-preferred first commercial content provider;
submitting a Web page request and receiving at least one Web page result responsive to the request;
identifying a position of a commercial content from a second commercial content provider in the Web page result, wherein the second commercial content provider is different from the user-preferred first commercial content provider;
generating a request to a server of the user-preferred first commercial content provider;
obtaining a separate response from the user-preferred first commercial content provider, the response comprising at least one commercial content provided by the first commercial content provider;
automatically modifying by replacing the commercial content received from the second commercial content provider in the Web page result at the positions identified with the at least one commercial content obtained from the user-preferred first commercial content provider,
displaying the modified Web page result with the substituted commercial content on a display screen of the user device.

15. The method of claim 14, wherein the recognition processing and automatic modification comprise using one of a document object model nodes, an HTML code, or an XML code.

16. The method of claim 14, further comprising:
storing the display at least one format preference in the memory of the user device;
extracting the at least one stored format preference; and
formatting the user-preferred first commercial content provider in the Web page result, in accordance with at least one format preference.

17. The method of claim 14, further comprising performing an automated recognition processing of a digital content of the Web page result by comparing it against a database of advertisement patterns and identifying the second commercial content provider, whose commercial content is included with the Web page result.

18. The method of claim 14, wherein the Web page request is transmitted through a network to a search engine, and the Web page result includes at least one commercial content from the second commercial content provider on one ore more Web pages.

19. The method of claim 14, further comprising:
receiving and storing a plurality of advertisement patterns used by the second commercial content provider;
replacing the commercial content included with the Web page result by using and applying said ad patterns for recognition processing.

20. The method system claim 19, further comprising:
updating the stored advertisement patterns with the changes to advertisement patterns and formats used by the second commercial content provider.

21. The method claim 14, further comprising:
providing user selection for at least one option, said option determining the display format of the Web page result;
storing the user selection;
applying the selected user option to determine the display format; and
displaying the Web page result on the user device based at least partially on the determined display format.

22. The method of claim 1, wherein the at least one Web page result responsive to the user request are presented and displayed to the user unchanged if a certain criteria, determined at least partially based on user preferences is met, and wherein the at least one Web page result responsive to the user request are presented and displayed to the user with modified and substituted commercial content from the preferred first commercial content provider.

23. The system of claim 1, wherein the at least one Web page result responsive to the user request are selectively presented and displayed to the user either unchanged, with blanked out commercial content, with blocked commercial content, or with formatted commercial content, and wherein the at least one Web page result responsive to the user request are presented and displayed to the user with modified and substituted commercial content from the preferred first commercial content provider based at least partially on the ad characteristics specified or determined for different commercial content providers.
